(19) United States
(12) Patent Application Publication
(10) Pub. No.: US 2003/0220919 A1
(43) Pub. Date: Nov. 27, 2003

(54) Intranet and internet search facility

(76) Inventor: Steven Tsitas, Collingwood (AU)

Correspondence Address: Edwin D. Schindler, Five Hirsch Avenue, P.O. Box 966, Coram, NY, 11727-0966, US

(21) Appl. No.: 10/440,457

(22) Filed: May 16, 2003

(30) Foreign Application Priority Data
May 17, 2002 (AU) PS2360

(51) Int. Cl. G06F 7/00

(52) U.S. Cl. 707/3

(57) ABSTRACT

The invention is a searching methodology whereby a computer based search facility is provided which searching methodology includes the steps of a user logging on to a site which provides the search facility, the user transmitting their query, communication becoming established between the user and researcher and the researcher returning the desired information

### TECHNICAL AREA

This invention relates to the area of Internet and or Intranet searching and in particular to the optimising of the process of a researcher carrying out research using the Internet or Intranet facilities.

### BACKGROUND TO THE INVENTION

Many companies and businesses are too small to maintain a research staff. Employees at these companies must research information on the internet themselves even though they may not be highly proficient at searching. This causes a lot of time to be wasted, which costs the company money, as the employees may not be adept at transforming their search requests into key words which are most appropriate for searching a specific query.

Large companies may have research staff but do not have an efficient way for employees to access them. For example employees may have to submit a written request for research to the corporate library which can take significant time before the best researcher for the job is identified and further time may be lost as the researcher has to contact the employee back by email or phone to clarify the research request. Furthermore employees cannot easily access the research department of other branches of the company in different geographical locations.

It would therefore be advantageous for employees of smaller firms to be able to access a competent internet researcher as and when a search is required and for employees of larger firms to efficiently access the company's research staff wherever they are located.

### OUTLINE OF THE INVENTION

It is an object of this invention to provide a means whereby any person or business requiring research into a particular topic can access a provider of a searching service who will carry out the search for that person or business and report back with the result.

The invention is an enquiry searching methodology whereby a computer based search facility is provided which searching methodology includes the steps of

a user logging on to a site which provides the search facility;

the user transmitting their query;

communication becoming established between the user and researcher and the researcher returning the desired information.

It may be preferred that the search methodology utilise the Internet however it can also be used on intranet facilities.

It is preferred that the search facility receives the query, the query is automatically made available to a number of possible researchers who, if interested, notify the search facility of their interest.

It is preferred that once a user is satisfied with the results obtained the user is able to approve payment of the searcher and/or grade the searcher's performance.

It is further preferred that this grading be on a points basis obtained from ratings received from successive customers for a particular searcher. It is also preferred that a significant number of searchers will be available such that, when a query is submitted to the web site, researchers will submit quotes which are provided together with each researcher's rating thereby enabling a user to make a choice of researcher.

In case users habitually do not approve payment of the researcher they can be banned from using the service. Queries could also be labelled with a rating which indicates to a researcher how often the person or business submitting the query has not approved payment in the past.

It is preferred that communication be established between a user and a researcher chosen permitting a user to clearly describe the search required and that the researcher be able to report back later.

In order that the invention may be more readily understood we shall describe by way of non limiting example a specific embodiment thereof with reference to the accompanying Figure.

### BRIEF DESCRIPTION OF THE DRAWING FIGURES

FIG. 1 is a flowchart of an Internet query dealt with in accordance with the invention;

FIG. 2 is an example of the appearance of a query processed by the method of the invention;

2.1 shows the log in procedure;

2.2 shows a query entry;

2.3 shows researcher selection options;

2.4 shows resultant communication;

FIG. 3 is a flowchart of an intranet query dealt with in accordance with the invention;

### DESCRIPTION OF EMBODIMENTS OF THE INVENTION

In a preferred embodiment of the invention its application to businesses which require search information will be discussed although the system could also be used by individuals. In particular, for convenience sake the invention will be discussed here in relation to searching using the Internet however it is to be understood that a similar methodology could be applied to intranet facilities.

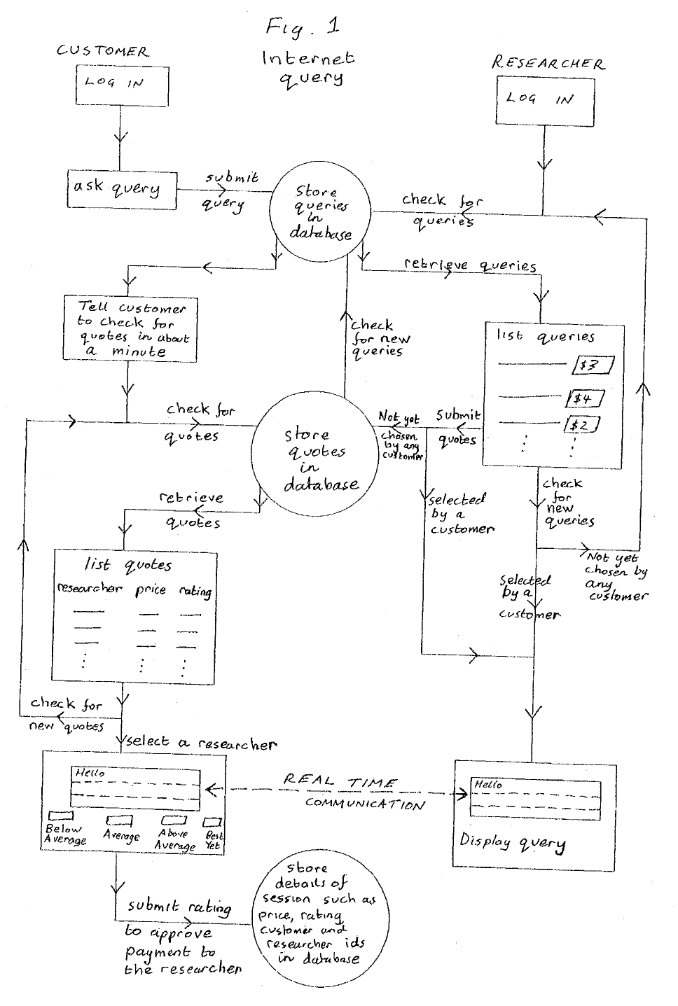

In this embodiment of the invention a search facility as shown in FIG. 1 is provided on a web site on the Internet which can supply a large base of researchers to carry out searching for businesses rather than an employee, who may well not be a skilled searcher in the particular field of the search, spending their time on such a pursuit. It is envisaged that any person in any country could sign up with the search facility thereby providing a broad base of searchers.

Of course it is probable that those who charge less would be preferred by users as searchers, however in order to maintain the quality control of the searchers it is necessary that the searchers be rated according to their performance as perceived by users.

Researchers are rated by users relative to other searchers on a basis of perhaps, above average, average or below average although any relative rating systems could be used. These relative ratings act to increase the standard of searching as a well rated searcher would be chosen over other searchers and be able to command a higher fee.

The system, as shown in FIG. 1, operates by a user logging in to the search facility and typing in a query which is immediately transmitted to a “query store database” accessible to searchers around the world who are registered with the search facility.

Searchers can check this database for new queries and those searchers who wish to carry out the search can then offer to carry out the search and submit a quotation.

A list of researchers is then returned to the user with their rating, as assessed on a points basis, and the user can then select the researcher of choice.

Automatic communication is then established between the user and the researcher chosen and they are able to communicate in real time. While the user otherwise goes about other tasks the researcher carries out the search and reports back giving relevant web sites which relate to the query or whatever other information is required.

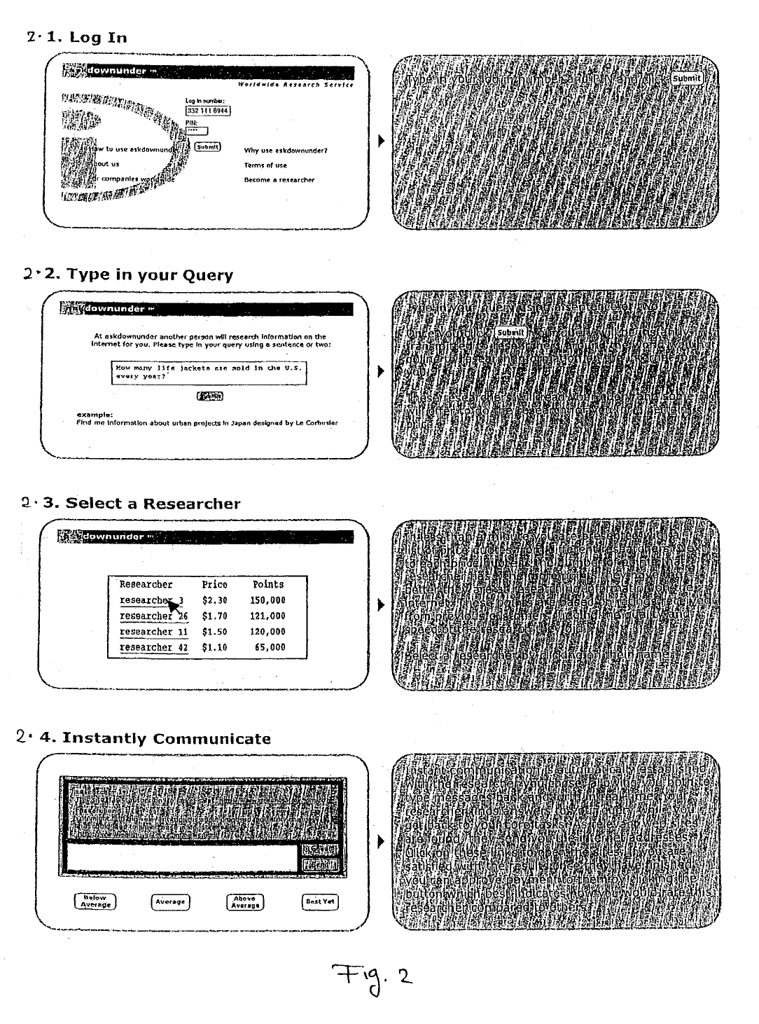

An example of the above process is shown in FIG. 2 which shows examples of screen associated with logging in, entry of a query, the type of screen returned for researcher selection followed by an example of screens associated with interactive user/researcher communication.

Once the user is satisfied with the results the user can approve payment of the researcher, and of course the search facility, and rate the performance of the researcher.

The search facility of the invention is scalable, immediate and automated, allowing it to replace the function of a search engine. This is particularly effective for business customers or users as it can potentially handle millions of queries a day and frees business personnel from carrying out such searches themselves and has the advantage that the searching can be carried out by those relatively proficient at the task.

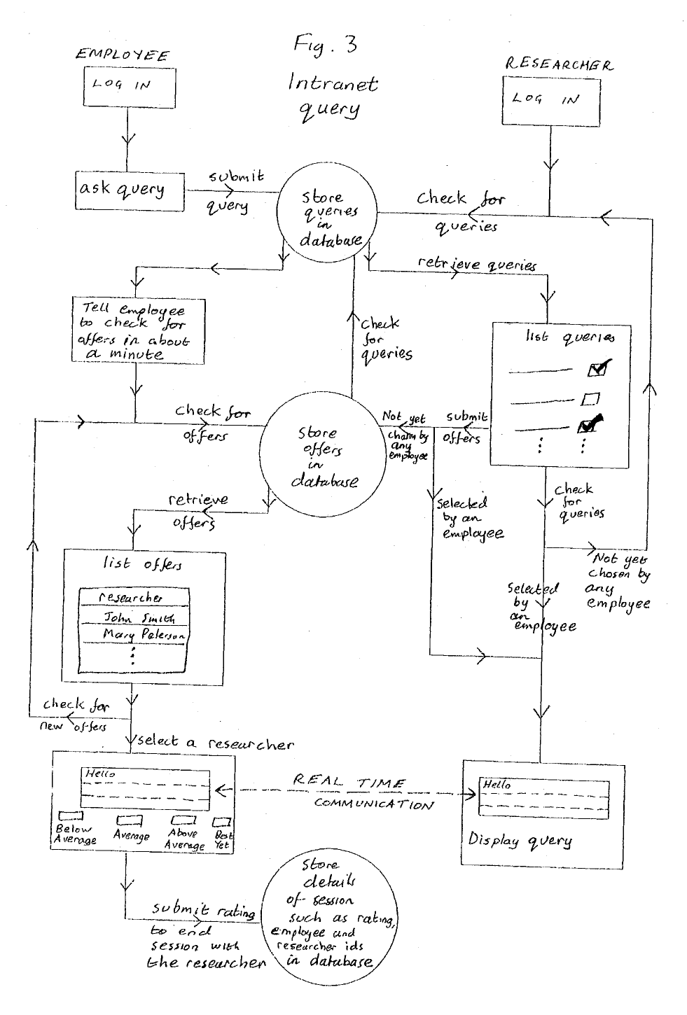

In a further embodiment of the invention the search methodology of the invention is used in relation to intranet searching. This methodology as shown in FIG. 3 is similar to that described in relation to Internet based searching however when applied to intranet searching however the price quotation is optional as it may not be appropriate for a company researcher to charge another employee for research assistance.

Further the word “research” as used in this specification is defined to include the input of information into an intranet database. Thus the methodology of the invention is the same however the user types in the query, being the subject of the information to be input, which the researchers can see and then offer to assist with the input (rather than the researching) of that information.

Whilst we have described herein specific embodiments of the invention it is envisaged that other embodiments of the invention will exhibit any number of and any combination of the features previously described and it is to be understood that variations and modifications in this can be made without departing from the spirit and scope of the invention.

I claim:

1. An enquiry searching methodology whereby a computer based search facility is provided which searching methodology includes the steps of
a user logging on to a site which provides the search facility;
the user transmitting their query;
communication becoming established between the user and researcher and the researcher returning the desired information.

2. A searching methodology as claimed in claim 1 including the step that as the search facility receives the query, the query is automatically transmitted to a database accessible to possible researchers who, if interested, notify the search facility of their interest.

3. A searching methodology as claimed in claim 2 wherein the searching methodology is used in an intranet environment.

4. A searching methodology as claimed in claim 3 including the step that as the search facility receives the query, the query is automatically transmitted to a database accessible to possible researchers who, if interested, notify the search facility of their interest.

5. An enquiry searching methodology whereby a computer based search facility is provided which searching methodology includes the steps of
a user logging on to a site which provides the search facility;
the user transmitting their query;
the search facility returning to the user a graded set of preferred searchers;
the user selecting a desired searcher;
communication becoming established between the user and researcher and the researcher returning the desired information.

6. A searching methodology as claimed in claim 5 including the step that as the search facility receives the query, the query is automatically transmitted to a database accessible to possible researchers who, if interested, notify the search facility of their interest.

7. A searching methodology as claimed in claim 6 wherein the searching methodology utilises the Internet

8. A searching methodology as claimed in claim 7 wherein once a user is satisfied with results obtained to a query the user is able to approve payment of the searcher and grade the searcher's performance.

9. A searching methodology as claimed in claim 8 wherein the searcher's performance grading is on a points basis obtained from ratings received from successive customers for a particular searcher.

10. A searching methodology as claimed in claim 9 wherein sufficient numbers of searchers are available such that, when a query is submitted to the web site, researchers will submit quotes which are provided together with each researcher's rating thereby enabling a user to make a choice of researcher.

11. A searching methodology as claimed in claim 10 wherein queries are labelled with a rating which indicates to a researcher how often the user submitting the query has not approved payment in the past.

12. A searching methodology as claimed in claim 11 in which interactive communication is established between a user and a researcher such that a user can clearly describe the search required and the researcher be able to report back.
